(19) United States
(12) Patent Application Publication
(10) Pub. No.: US 2012/0116609 A1
(43) Pub. Date: May 10, 2012

(54) SYSTEM AND METHOD FOR PROVIDING VEHICLE DIAGNOSTIC SERVICE

(75) Inventors: Sang Yong Jung, Suwon (KR); Chi Nam Oh, Suwon (KR)

(73) Assignees: KIA MOTORS CORPORATION, Seoul (KR); HYUNDAI MOTOR COMPANY, Seoul (KR)

(21) Appl. No.: 13/073,475

(22) Filed: Mar. 28, 2011

(30) Foreign Application Priority Data
Nov. 10, 2010 (KR) 10-2010-0111735

(51) Int. Cl. G06F 7/00

(52) U.S. Cl. 701/2

(57) ABSTRACT

A system and method for providing vehicle diagnostic service, in which a central server cumulatively stores diagnostic trouble codes (DTCs) of vehicles, analyzes a problem history based on the DTCs, determines whether a vehicle has a problem or not using the analyzed result, notifies a driver of problem information, and remotely controls a diagnostic period and a diagnostic time for the problemed diagnostic item to perform the intensive diagnostics so that it is possible to allow the driver to promptly manage the problem.

### CROSS-REFERENCES TO RELATED APPLICATIONS

The priority of Korean patent application No. 10-2010-0111735 filed on Nov. 10, 2010, the disclosure of which is hereby incorporated in its entirety by reference, is claimed.

### BACKGROUND OF THE INVENTION

1. Field of the Invention

The present invention relates to a vehicle diagnostic service, and more particularly to a vehicle diagnostic service in which a central server senses problem related to a vehicle and informs a driver of the problem and remotely controls a diagnostic period and time.

2. Description of the Related Art

Recently, one of remarkable technologies is a telematics technology for a vehicle.

The telematrics system for a vehicle is a system which combines a mobile communication technology, a location tracking technology and the Internet to detect a car accident, robbery, or the like, guides a driving route of a vehicle, and provides other various kinds of information and the like to a driver of the vehicle. That is, the telematics system for a vehicle is a system which provides various kinds of information to the vehicle based on mobile communication and a global positioning system (GPS).

Beneficially, telematics allows an automobile industry and an information industry to be combined in order to create additional value-added services capable maximizing a synergy effect.

Because of this, a telematics standardization group has been established and the standardization group currently performing standardization for operations and functions of components in telematics systems and services through communication protocols and communication networks between components.

Accordingly, it would be beneficial to utilize the telematics system to provide services to customers accordingly.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention have been made in view of the above problems, and provide vehicle diagnostic service in which a center notifies a driver of a problem in a vehicle to promptly respond to the problem the vehicle and remotely controls a diagnostic period and a diagnostic time.

According to an aspect of the present invention, a system of providing vehicle diagnostic service includes a diagnostic unit and a control unit. The diagnostic unit is configured to analyze a cumulatively stored diagnostic trouble code (DTC) to analyze a problem history for a specific vehicle. The control unit, on the other hand, compares a DTC received from a telematics device of a vehicle with the problem history to determine whether there is a problem in the vehicle or not, notifies a driver of problem information when the vehicle is determined to have a problem, generates a control signal for adjusting a diagnostic period for an item associated with the problem, and transmits the control signal to the telematics device of the vehicle.

The diagnostic unit may divide the DTC by a diagnostic item and then calculate a statistic value for a problem state for each diagnostic item. At this time, the control unit may check a proximity degree relating to how close a current state of each item in the received DTC is to the statistic value and determine the current state as a problem state if the proximity degree reaches a reference value.

In some embodiments of the present invention, the diagnostic unit may collect all the DTCs for the same items of the same kind of vehicles which are subscribed in the service and analyze the problem history for that kind of vehicle.

The control unit may then transmit a request for information relating to details of the problem and a response procedure for correcting or fixing the problem to a predesignated user terminal. In addition, the control unit may control the diagnostic period with a diagnostic time. At this time, the control unit may make a diagnostic period for the item associated with the problem shorter and make a diagnostic time for the item associated with the problem longer.

According to an aspect of the present invention, a method of providing vehicle diagnostics services includes cumulatively storing a diagnostic trouble code (DTC) of a vehicle, analyzing a problem history for the DTC cumulatively stored, comparing the problem history with a DTC received from a telematics device to check whether the vehicle has a problem or not, and in response to the vehicle having a problem, notifying a driver of the problem information and adjusting a diagnostic period for a diagnostic item associated with the problem.

In some embodiments of the present invention, analyzing a problem history may include calculating a statistic value of a problem state for each diagnostic item after dividing the DTC by the diagnostic item. Analyzing a problem history may also include collecting a DTC for the same diagnostic items of the same kind of vehicles subscribed in the service to analyze the problem history of that kind of vehicle.

Additionally, checking whether the vehicle is has a problem or not may include checking a proximity degree related to how closed a current state of each diagnostic item in the received DTC is to the statistic value and determining the current state as a problem state if the proximity degree reaches a reference value.

In some embodiments of the present invention, adjusting the diagnostic period may include adjusting the diagnostic period with a diagnostic time.

The systems and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a configuration diagram illustrating a configuration of an exemplary system for providing a vehicle diagnostic service according to an exemplary embodiment of the present invention.

FIG. 2 is a configuration diagram detailedly illustrating a configuration of an exemplary vehicle diagnostic server according to an exemplary embodiment of the present invention.

FIG. 3 is a flow chart illustrating a method of providing vehicle diagnostic service according to an exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

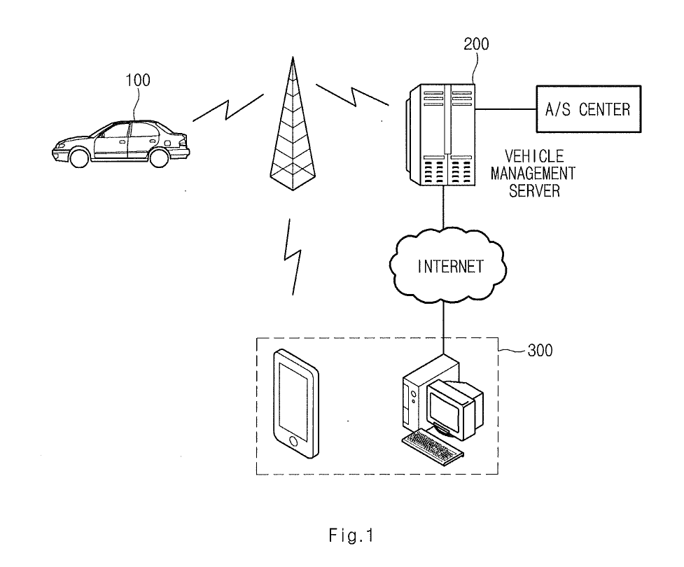

FIG. 1 is a configuration diagram illustrating an exemplary configuration of a system of providing vehicle diagnostic service according to an exemplary embodiment of the present invention.

As shown in FIG. 1, the system includes a telematics device 100, a vehicle diagnostic server 200 and a user terminal 300.

The telematics device 100 measures a state of a vehicle according to a fixed diagnostic period and diagnostic time which are set for a diagnostic item. The telematics device 100 generates a diagnostic trouble code (DTC), and transmits the DTC to the vehicle diagnostic server 200 via a wireless communication network such as wireless fidelity (WIFI), wireless broadband (WIBRO), code division multiple access (CDMA), wideband code division multiple access (WCDMA), or global system/standard for mobile communication (GSM). That is, when the telematics device 100 performs diagnostics for configuration elements of the vehicle, the telematics device 100 does not necessarily collectively perform diagnostics for all configuration elements, but rather divides the diagnostics items by an item (e.g., an intake series, an ignition series, an exhaust gas series, a break series, an engine series, a battery series, and the like) and then separately performs diagnostics each item. More specifically, the diagnostic period and the diagnostic time are remotely controlled by the vehicle diagnostic server 200. In addition, if the telematics device 100 receives a message (e.g., an alarm message) informing the telematics device of problem information from the vehicle diagnostic server 200, the telematics 100 briefly informs the driver of an problem occurrence through an audio/video device (not shown) and if the driver presses a specific button (e.g., vehicle care button), the telematics device 100 may be configured to further inform the driver of any details related to a corresponding problem and a response procedure for the problem (including location information of an after-sales (A/S) center).

When the vehicle diagnostic server 200 receives the DTC from the telematics device 100, the vehicle diagnostic server 300 analyzes the DTC, and notifies the user terminal 300 and/or the telematics device 100 of any problem information. That is, the vehicle diagnostic server 200 cumulatively manages the DTC, analyzes a problem history (e.g., a statistics value) pertaining to particular a diagnostic item, compares a current DTC with the problem history to check whether the vehicle is has a problem or not, and notifies the user terminal 300 and/or the telematics device 100 if it is determined that the vehicle has a problem. The occurrence of a problem may not necessarily mean that the vehicle definitely has a problem, but rather that the vehicle is likely to become problemed. For example, the vehicle diagnostic server 200 may calculate a proximity degree relating to how closed a current state of the vehicle is to a problem state of the past and determine the vehicle is in a problem state if the proximity is larger than a reference value, for example 80% likelihood.

Specifically, the vehicle diagnostic server 200 may transmit a control signal for adjusting a diagnostic period and a diagnostics time for a corresponding diagnostic item to a corresponding telematics device 100 if there is a diagnostic item which is related to the problem according to a diagnostic result. Accordingly, the vehicle diagnostic server 200 may intensively perform the diagnostics for the corresponding item. In addition, when the vehicle is determined to have a problem, the vehicle diagnostic server 200 may transfer the problem information to a remote, A/S center (e.g., an auto repair shop) selected by a user and allow the user to make a reservation for vehicle inspection.

The user terminal 300 is a driver terminal and receives the diagnostic result for the vehicle from the vehicle diagnostic server 200 and display the diagnostic result on a screen.

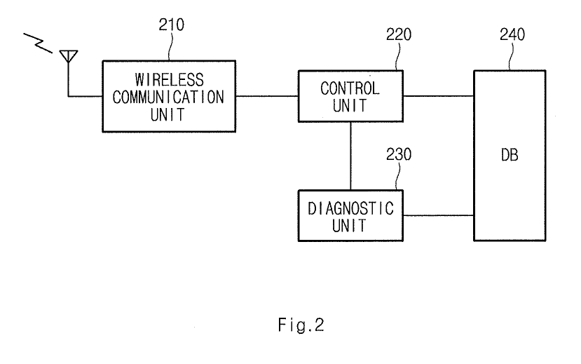

FIG. 2 is a construction diagram detailedly illustrating an exemplary configuration of the vehicle diagnostic sever 200 of FIG. 1.

The vehicle diagnostic server 200 includes a wireless communication unit 210, a control unit 220, a diagnostic unit 230, and a database 240.

The wireless communication unit 210 transmits/receives data to/from the telematics device 100 and/or the user terminal 300 according to the predefined communication protocol. The wireless communication unit 210 may transmit and receive the data through a wireless communication technology such as a mobile communication technology (CDMA, WCDMA, or the like) or a wireless internet technology (WIBRO).

The control unit 220 controls the overall operation of the vehicle diagnostic server 200. The control unit 220 divides the DTC received from the telematics device 100 by each vehicle to cumulatively store the divided DTC in the database 250. The diagnostic results of the diagnostic unit 230 are compared with a newly received DTC determine if there is an item that has a problem in the vehicle. If there is an item that has a problem, the control unit 220 transmits the problem information to the vehicle diagnostic server 200 and/or the telematics device 100. The control unit 220 generates a control signal for adjusting a diagnostic period and diagnostic time of the diagnostic item in which a problem is caused or the likelihood of a problem is larger than a constant level, and transmits the control signal to a corresponding telematics device 100. At this time, the control unit 220 may add the information for the A/S centers around a driver's house and/or a current location of the vehicle and transmit the problem information including the information for the A/S centers to the driver, so that the control unit 220 allows the driver to select a desired A/S center and make a reservation for inspection.

The diagnostic unit 230 analyzes the problem history (e.g., a statistic value) of the DTC cumulatively stored in the database 240, according to diagnostic item, to find out the statistic value for a particular time point when a corresponding item entered a problem state, and stores the analyzed result in the database 240. Additionally, the diagnostic unit 230 analyzes the problem history of the past for the same items of the same kind of vehicles to identify statistic information relating to a problem state at a particular period of time then an element of each item was actually in a problem state, and stores the statistic information in the database 240.

The database 240 stores information required to provide the service according to the present invention, such as the driver information, the DTC received from the telematics device 100, the information for the diagnostic result, the problem response procedure for each diagnostic item and the information for the A/S center.

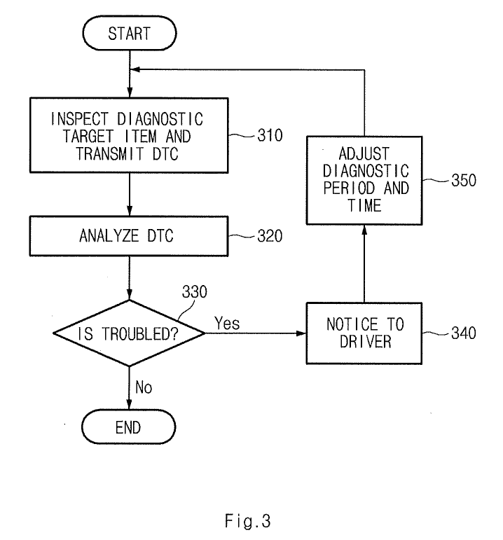

FIG. 3 is a flowchart illustrating a method of providing vehicle diagnostic service according to the present invention.

First, the telematics device 100 of vehicles which are subscribed in the service according to the present invention inspects a state of a corresponding item according to a diagnostic period and diagnostic time for each item, generates a DTC, and transmits the DTC to the vehicle diagnostic server 200 via a wireless communication network (e.g., CDMA, WCDMA, GSM, WIFI, WIBRO, Bluetooth, or the like) (S310).

The control unit 220 then cumulates accordingly the time received and stores the DTC received from the wireless communication unit 210 with matching vehicle information in the database 240.

If more than a predetermined amount of the DTC is cumulated, the diagnostic unit 230 analyzes a problem history (statistic value) for the DTC cumulatively stored (S320).

For example, the diagnostic unit 230 divides the DTC cumulatively stored for a fixed period by a specific diagnostic item and collects problem information for each specific diagnostic item to investigate the problem history. At this time, the diagnostic unit 230 may collect all DTCs for the same diagnostic items of the same kind of vehicles subscribed in the service to investigate the problem history. Thus, the diagnostic unit 230 identifies information relating to the time when diagnostic item for each vehicle actually was in the problem state and stores the information in the database 240 accordingly.

Next, when the DTC is received, the control unit 220 compares current state information of the vehicle with the analyzing result of the diagnostic unit 230 to check whether there is an item in which has a problem or not (S330).

For example, the control unit 220 checks a proximity degree relating to how much close the current state of the vehicle for each item is to a problem statistic value of the past for a corresponding item in the received DTC and then checks whether the proximity degree reached a predetermined reference value or not. At this time, the problem statistic value is able to identify when a problem is most frequently generated by each item.

In the case where there is an item identified as having a problem, the control unit 220 transfers the problem information to the user terminal 300 and the telematics device 100 (S340).

For example, if the user terminal 300 is a mobile communication terminal, the control unit 220 may notify the user of the problem information via a multimedia message service (MMS) or a short message service (SMS). If the user terminal 300 is, for example, a PC, the control unit 220 may notify the problem information via E-mail. Additionally, the problem information may include details for a corresponding problem, a response procedure for the corresponding problem, and information for an A/S center.

If the problem information is transmitted to the telematics device 100, the telematics 100 briefly informs the driver of the problem through an audio/video device and then, if the driver presses a specific button, the telematics device 100 may further inform the driver of details corresponding to the problem and a response procedure for correcting or fixing the problem. The telematics device 100 may also provide the information for the A/S centers around a driver's house and/or a current location of the vehicle via a reservation menu together with the problem information. Thus, if the driver selects a specific A/S center and inputs reservation information, the telematics device 100 transfers the problem information and the problem information to the selected A/S center to make a reservation for inspection.

Next, the control unit 220 generates a control signal for adjusting the diagnostic period for a diagnostic item having a problem to be shorter and the diagnostic time for the diagnostic item having a problem to be longer so as to perform intensive diagnostics for that specific diagnostic item. The control unit then transmits the control signal to the telematics device 100. For example, if it is assumed that the diagnostics for the corresponding item is performed for 5 seconds at an interval of 5 minutes and the DTC is transmitted to the vehicle diagnostic server 200 in advance, the control unit 220 may adjust that the diagnostics for the corresponding item so that it is performed for 30 seconds at an interval of 1 minute.

For instance, the embodiment as described above illustrates that after the problem is caused, the diagnostic period and diagnostic time are adjusted. However, the control unit may also adjust the diagnostic period and time even if there is only a high probability of a problem. That is, in S330 described above, even in the case where the current state of the vehicle has not reached the reference value, but the current state of the vehicle has reached the a predetermined level of the current state of the vehicle, the control unit 220 may adjust the diagnostic period and diagnostic time to perform intensive diagnostics.

In addition, for convenience of description, the embodiment as described above illustrates that the diagnostic unit 230 is separately configured, but functions of the diagnostic unit 230 and the control unit 240 may be integrally configured as one configuration element.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system of providing vehicle diagnostic service, the system comprising:
a diagnostic unit which analyzes a cumulatively stored diagnostic trouble code (DTC) to analyze a problem history for each vehicle; and
a control unit which compares a DTC received from a telematics device of a vehicle with the problem history to determine whether the vehicle has a problem or not, notifies a driver of problem information when the vehicle has a problem, generates a control signal for adjusting a diagnostic period for an item having a problem, and transmits the control signal to the telematics device of the vehicle.

2. The system according to claim 1, wherein the diagnostic unit divides the DTC by diagnostic item and calculates a statistic value of a problem state for each diagnostic item.

3. The system according to claim 2, wherein the control unit checks a proximity degree relating to how close a current state of each item in the received DTC is to the statistic value and determines the current state is a problem state if the proximity degree reaches a reference value.

4. The system according to claim 1, wherein the diagnostic unit collects DTCs for the same types of items of the same kinds of vehicles respectively which subscribe to a service and analyze the problem history accordingly.

5. The system according to claim 1, wherein control unit transmits information for details of the problem and a response procedure for the problem to a predesignated user terminal.

6. The system according to claim 1, wherein the control unit controls the diagnostic period with a diagnostic time.

7. The system according to claim 6, wherein the control unit makes a diagnostic period for the item having the problem shorter and makes a diagnostic time for the item having the problem longer.

8. A method of providing vehicle diagnostic service, the method comprising:
storing cumulatively a diagnostic trouble code (DTC) of a vehicle;
analyzing a problem history for the DTC cumulatively stored;
comparing the problem history with a DTC received from a telematics device to determine whether the vehicle is has a problem or not; and
in response to determining that the vehicle has a problem, notifying a driver of the problem information and adjusting a diagnostic period for a diagnostic item having a problem.

9. The method according to claim 8, wherein the analyzing a problem history includes calculating a statistic value for a problem state according to each diagnostic item after dividing the DTC by the diagnostic item.

10. The method according to claim 9, wherein the analyzing a problem history includes collecting a DTC for the same diagnostic items of the same kind of vehicles subscribed in the service to analyze the problem history.

11. The method according to claim 10, wherein the checking whether the vehicle has a problem includes checking a proximity degree relating to how closed a current state of each diagnostic item in the received DTC is to the statistic value and determining the current state is a problem state if the proximity degree reaches a reference value.

12. The method according to claim 8, wherein the adjusting a diagnostic period includes adjusting the diagnostic period with a diagnostic time.

13. A system for providing vehicle diagnostic service to a user, the system comprising:
a diagnostic unit configured to analyze cumulatively stored codes by analyzing a problem history for each vehicle; and
a control unit configured to compare each code received from a telematics device of a vehicle with the problem history to determine whether the vehicle has a problem or not, wherein in response to the control unit determining that there is a problem with the vehicle, the control unit is further configured to notify a driver of problem information, generate a control signal for adjusting a diagnostic period for an item having a problem, and transmit the control signal to the telematics device of the vehicle.

14. The system according to claim 13, wherein the diagnostic unit divides the codes according to an item within the vehicle it is related to and calculates a value of a problem state for each item.

15. The system according to claim 14, wherein the control unit checks a proximity degree relating to how close a current state of each item in the received code is to the calculated value and determines the current state is a problem state if the proximity degree reaches a reference value.

16. The system according to claim 13, wherein the diagnostic unit collects codes for the same types of items of the same kinds of vehicles respectively which subscribe to a service and analyze the problem history accordingly.

17. The system according to claim 13, wherein control unit transmits information for details of the problem and a response procedure for the problem to a predesignated user terminal.

18. The system according to claim 17, wherein the control unit makes a diagnostic period for the item having the problem shorter and makes a diagnostic time for the item having the problem longer.
